(19) United States
(12) Patent Application Publication
(10) Pub. No.: US 2020/0125161 A1
(43) Pub. Date: Apr. 23, 2020

(54) CONTROLLING COMPUTING DEVICE FUNCTIONALITY BASED ON A COGNITIVE DETERMINATION THAT A CHARGING OUTLET IS AVAILABLE

(71) Applicant: International Business Machines Corporation, Armonk, NY (US)

(72) Inventors: Ali Y. Duale, Poughkeepsie, NY (US); Louis P. Gomes, Poughkeepsie, NY (US); Shailesh R. Gami, Poughkeepsie, NY (US); Rajaram B. Krishnamurthy, Pleasant Valley, NY (US)

(21) Appl. No.: 16/165,399

(22) Filed: Oct. 19, 2018

(51) Int. Cl. G06F 1/32; G06N 99/00; H04W 4/33

(52) U.S. Cl. CPC G06F 1/3287; H04W 4/33; G06N 99/005

(57) ABSTRACT

Embodiments of the invention are directed to a computer-implemented method of operating a computing device. The computer-implemented method includes receiving, using a processor of the computing device, indoor positioning data and object detection data. Based on an analysis of the indoor positioning data and the object detection data, the processor is used to make a determination that a current location of the computing device is a charging outlet location. The computer-implemented method further includes using the processor to disable a limited functionality mode of the computing device based at least in part on the determination that the current location of the computing device is a charging outlet location.

### BACKGROUND

The present invention relates generally to programmable computer systems, and more specifically to computer-implemented methods, computer systems and computer program products configured to control computing device functionality based on computer-based cognitive determinations that the computing device is currently in a location where a charging outlet is likely to be available.

Mobile computing devices are hand-held devices that have the hardware, software, and batter power required to execute typical desktop and web-based applications. Mobile computing devices have similar hardware and software components as those used in personal computers (PCs), such as processors, random memory and storage, Wi-Fi, and a base operating system (OS). However, they differ from PCs in that they are built specifically for mobile architectures and to enable portability. Among the common examples of mobile computing devices include tablet PCs, personal digital assistants (PDAs), laptops, smartwatches, or smartphones, each of which includes a built-in processor, memory and OS that are capable of executing a wide variety of computer software application programs. Providing mobile computing devices with a rechargeable battery is a key component for enabling the computing device's mobility. Because of their mobility, mobile computing devices make computing power and connectivity available to users in virtually any environment.

### SUMMARY

Embodiments of the invention are directed to a computer-implemented-method of operating a computing device. The computer-implemented method includes receiving, using a processor of the computing device, indoor positioning data and object detection data. Based on an analysis of the indoor positioning data and the object detection data, the processor is used to make a determination that a current location of the computing device is a charging outlet location. The computer-implemented method further includes using the processor to disable a limited functionality mode of the computing device based at least in part on the determination that the current location of the computing device is a charging outlet location.

Embodiments are further directed to computer systems and computer program products having substantially the same features as the above-described computer-implemented method.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 is a block diagram of a system embodying aspects of the invention;

FIG. 2 is a block diagram illustrating an example of an energy/application map embodying aspects of the invention;

FIG. 3 is a block diagram illustrating an example of a cognitive charging outlet availability classifier embodying aspects of the invention;

FIG. 4 is a flow diagram illustrating a methodology embodying aspects of the invention; and

FIG. 5 is a computer system capable of implementing aspects of the invention.

In the accompanying figures and following detailed description of the disclosed embodiments, the various elements illustrated in the figures are provided with three digit reference numbers. The leftmost digit of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to a more detailed description of technologies that are more specifically related to aspects of the invention, improvements in the computational speed, size, and portability of computing systems/devices have enabled the continued integration of computer functionality into everyday life. For example, small mobile computing systems, such as miniaturized computers, input devices, sensors, detectors, image displays, wireless communication devices as well as image and audio processors, can be integrated into computing devices that fit easily in a user's pocket or travel bag. Hence, computing devices are now present in any environment where users are present.

The portability of a computing device is enabled by using a rechargeable battery as its energy source. Rechargeable batteries can use a variety of technologies, the most common of which is known as lithium ion. In general, virtually all mobile computing devices such as tablet PCs, PDAs, laptops, smartwatches, smartphones, and the like use lithium-ion rechargeable batteries. A typical rechargeable battery used in a computing device can provide anywhere from about 3 to as many as 10 years of useful life depending on how the computing device is used. In general, the more features that are available and used on a computing device, the more quickly a battery's charge will be drained, and the more frequently the battery will have to be recharged.

Turning now to an overview of aspects of the present invention, embodiments of the invention are directed to computer-implemented methods, computer systems and computer program products configured and arranged to control computing device functionality based on computer-based cognitive determinations that the computing device is currently in a location where a charging outlet is likely to be available. In accordance with aspects of the invention, the terms “charging outlet” are used to identify any receptacle that provides a place in a wiring system where current can be taken to charge a rechargeable battery or run an electrical devices. In embodiments of the invention, the computing device can be a mobile computing device, examples of which include smartphones, smartwatches, PDAs, tablets, laptops, e-readers, portable entertainment devices, and the like. In embodiments of the invention, the computing device is configured and arranged to dynamically manage how the energy storage element (e.g., rechargeable battery) of the computing device operates. In some aspects of the invention, the computing device can be configured to utilize cognitive computing algorithms to extract features from training data in order to construct a model of the environment in which the computing device is currently located. In accordance with aspects of the invention, the model of the environment in which the computing device is located includes whether or not a charging outlet is available in the environment. This model is referred to herein as a charge outlet location (COL) model. As an example, the COL model can be used to evaluate data about the computing device's current environment to determine, for example, that the computing device is currently located in an automobile that is likely to have a charging outlet coupled to the automobile's battery. As another example, the COL model can be used to evaluate data about the computing device's current environment to determine that the computing device is currently located in a home that is likely to have a conventional electrical outlet. As still another example, the COL model can be used to evaluate data about the computing device's current environment to determine that the computing device is currently located in a public park that is unlikely to have a charging outlet. The COL model can be generated by classifying the training data (received from various sources) and identifying relationships between and among the classified training data.

The training data used to create the COL model can come from a variety of sources. For example, in embodiments of the invention, the computing device is configured to determine the computing device's location (e.g., using global positioning (GPS) data or data from an indoor positioning system of the computing device) whenever the computing device is charging, thereby marking that location as a charging outlet location. As an example, if a user of the computing device plugs the computing device into a charging outlet at a charging station in O'Hare airport's terminal 3 while waiting for a departing flight, the computing device will determine (e.g., using GPS data or data from an indoor positioning system of the computing device) that the computing device is at terminal 3 of O'Hare airport while being charged, and will store training data that identifies terminal 3 of O'Hare airport as a potential charging outlet location. As another example, in embodiments of the invention, the computing device is configured to utilize location related data (e.g., using global positioning (GPS) data or data from an indoor positioning system of the computing device), along with object identification data (e.g., using object identification systems of the computing device) in order to determine a likelihood that the current location of the computing device is a charging outlet location. The computing device can determine that its current location is likely a charging location based on a determination that the current location is a residence, and based on a determination that the current location includes objects (e.g., appliances and/or other electronics) that require a charging outlet to operate. The computing device would then store training data that identifies the current location of the computing device as at a potential charging outlet location.

In accordance with aspects of the invention, the computing device is further configured and arranged to, based on a determination of whether or not the computing device is currently charging or at a charge outlet location, place the computing device in a limited functionality mode. The limited functionality mode can be configured to disable certain functions of the computing device when the energy storage level of the computing device reaches a predetermined level. For example, limited functionality mode can be configured to disable games and video functionality of the computing device when the energy storage level of the computing device reaches 30%. The configuration of the limited functionality mode can be set by the user based on user preferences. The computing device can be configured to assist the user in setting the user preferences by identifying to the user functions of the computing device that deplete energy storage levels the fastest, or by identifying to the user functions that of the user implements less frequently than other functions.

In aspects of the invention, the computing device can be configured to discontinue or block the limited functionality mode when the computing device is being charged. In aspects of the invention, the computing device can be configured to discontinue or block the limited functionality mode when the computing device determines that the computing device is located at a charging outlet location. In aspects of the invention, the computing device can be configured to initiate or not interrupt the limited functionality mode when the computing device determines that the computing device is not located at a charging outlet location. In embodiment of the invention, the computing device can be configured to issue an alert to the user of the computing device when the computing device determines that the computing device is at a charging location. In embodiment of the invention, the computing device is configured to accept, in response to the user alert, an override (e.g., from the user) that allows the mobile computing device to initiate or continue the limited functionality mode notwithstanding the computing device having determined that the computing device is at a potential charging outlet location.

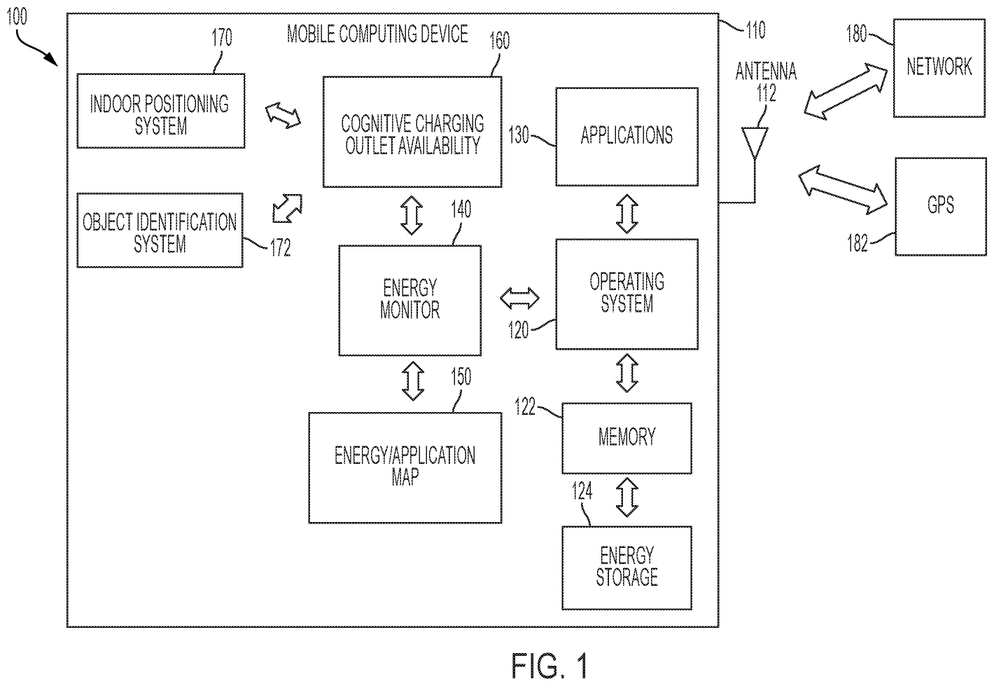

Turning now to a more detailed description of aspects of the invention, FIG. 1 depicts an example of a system 100 embodying aspects of the present invention. The system 100 includes a mobile computing device 110 configured to communicate, through an antenna 112, with a network 180 and a GPS 182. The mobile computing device 110 includes an operating system 120, a memory 122, energy storage (e.g., a rechargeable battery) 124, applications 130, an energy monitor module 140, an energy/application map module 150, a cognitive charging outlet availability module 160, an indoor positioning system 170, and an object identification system 172, configured and arranged as shown. The various components/modules of the system 100 are depicted separately for ease of illustration and explanation. In embodiments of the invention, the functions performed by the various components/modules of the system 100 can be distributed differently than shown. For example, some or all of the functionality of the indoor positioning system 170 could be integrated with some or all of the functionality of the object detection system 172. Additionally, the bidirectional arrows between the operating system 120, the memory 122, the energy storage 124, the applications 130, the energy monitor module 140, the energy/application map module 150, the cognitive charging outlet availability module 160, the indoor positioning system 170, and the object identification system 172 are provided to indicate that data, controls and other signals can be passed through a variety of paths between any of the components of the mobile computing device 110.

In embodiment of the invention, the illustrated components of the mobile computing device 110 can be implemented as one or more modules. Embodiments of the present invention apply to a wide variety of module implementations. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, form the module and achieve the stated purpose for the module.

In accordance with aspects of the invention, the applications 130 are various types of application programming instructions configured to implement various types of functionality of the mobile computing device 110. For example, the applications 130 can include games, radio operations, playing videos, internet-related functions, navigation functions, sending text messages, and implementing voice related operations such as phone calls. The applications 130 can be stored in the memory 122. The operating system 120 includes an interpreter (not shown) that interprets and executes the various programming instructions that form the applications 130. The energy storage 124 provides electric power to the various components/modules of the mobile computing device 110 and can be implemented as a rechargeable battery. The energy monitor 140 includes circuitry configured to monitor status of energy storage 124, including, for example, whether or not the energy storage 124 is charging, along with the remaining energy stored at the energy storage 124. The remaining energy stored at the energy storage 124 can be expressed as a percentage.

The indoor positioning system 170 includes the various positioning-enabled sensors such as GPS receivers, accelerometers, gyroscopes, digital compasses, cameras, Wi-Fi etc. that have been built into the mobile computing device 110. The indoor positioning system 170 can also be described as a hybrid positioning system that relies on several different positioning technologies, including, for example, GPS, cell tower signals, wireless internet signals, Bluetooth sensors, IP addresses, and network environment data. These systems are specifically designed to overcome the limitations of GPS, which is very exact in open areas, but works poorly indoors or between tall buildings (the urban canyon effect). By comparison, cell tower signals are not hindered by buildings or bad weather, but usually provide less precise positioning. Wi-Fi positioning systems can give very exact positioning, in urban areas with high Wi-Fi density but depend on a comprehensive database of Wi-Fi access points.

The object identification system 172 can be implemented using a variety of technologies including image-based and/or acoustic-based object identification technologies. Image-based object identification can rely on a camera system of the mobile computing device 110, along with image processing algorithms to identify the objects in the image. Acoustic-based object identification can be implemented as, for example, an acoustic pulse-echo system that include a source of ultrasonic energy, an ultrasonic transducer coupled to the source for emitting a narrow pulse or series of pulses of ultrasonic energy, a second ultrasonic transducer for receiving return pulses from objects within a predetermined detection zone, and a detection circuit coupled to the ultrasonic transducer for providing output signals when a predetermined criterion is met by the return pulses. The output signals can be analyzed by known algorithms to generally identify classes of objects. For example, in accordance with aspects of the invention, the algorithms can be configured to identify objects (e.g., appliances, desktop computers, fans, and the like) that require electricity to operate. In some embodiment of the invention, the acoustic-based object identification can be implemented based on audible noise generated by the object (e.g., a refrigerator operating).

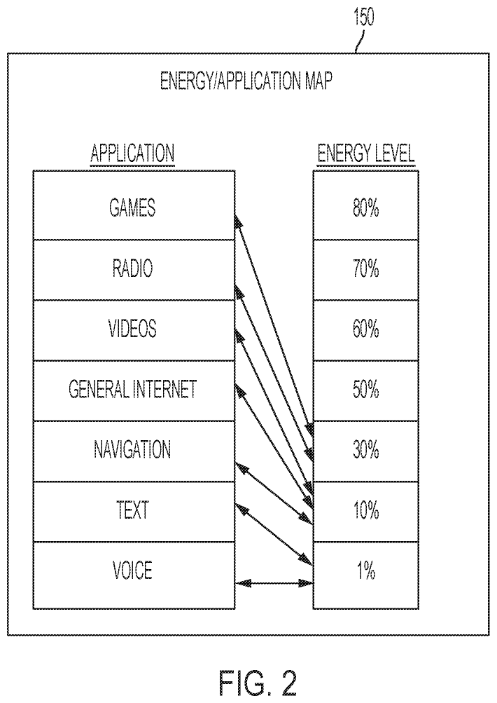

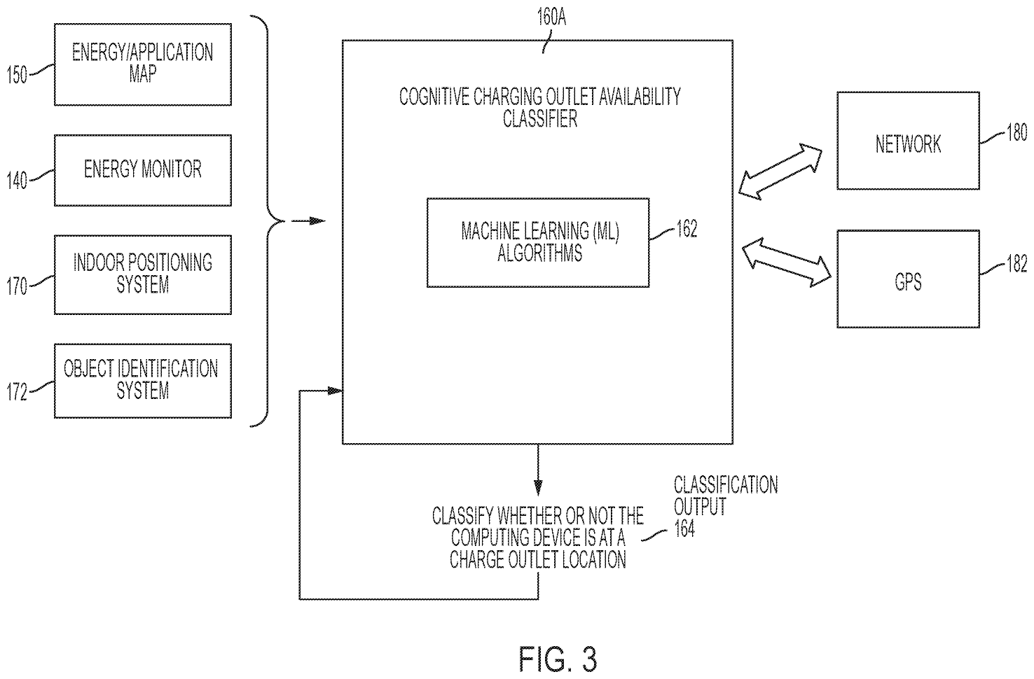

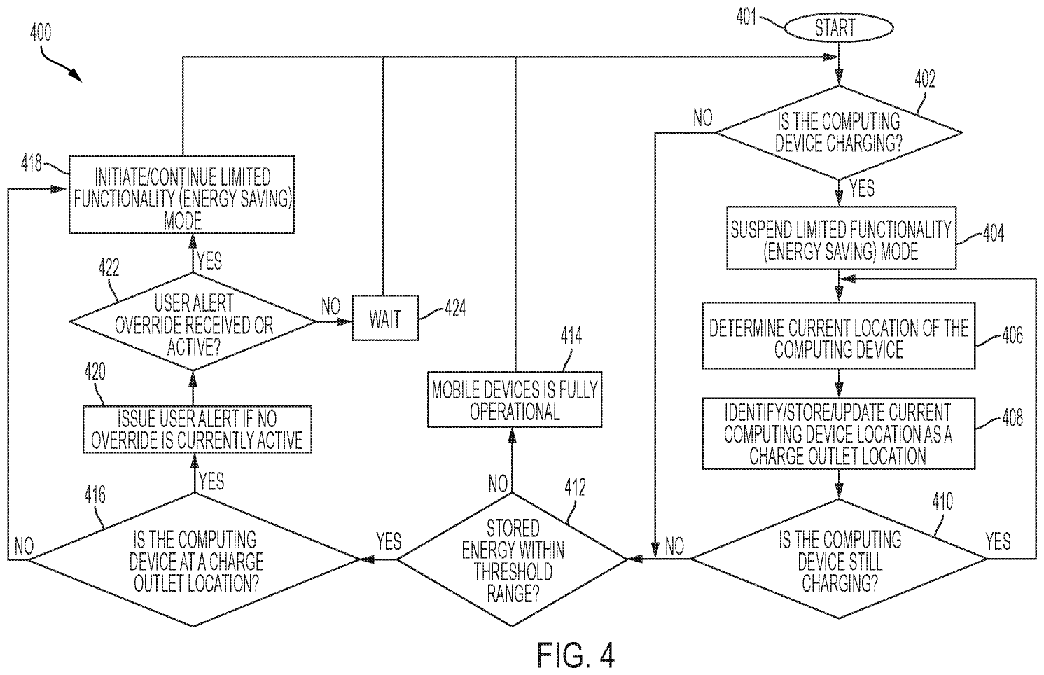

The energy/application map 150 can be utilized by the operating system 120 to selectively enable or disable selected ones of the applications 130. An example of a user generated energy/application map 150 is shown in FIG. 2. Referring now to FIGS. 1 and 2, in accordance with aspects of the invention, a user of the mobile computing device 110 can divide the applications 130 into N number of categories, wherein each category can be associated with a percentage of the charge level remaining in the energy storage 124. When the charge level of the energy storage 124 reaches any of the user defined level, the operating system 120 is configured to, under the conditions described herein (e.g., as shown in FIGS. 3 and 4), disable all associated applications 130 that have been mapped to the particular user defined level while leaving other applications to run with their normal operations.

In embodiments of the invention, the energy/application map 150 depicted in FIG. 2 can be implemented as a relational database that is located in memory 122 (shown in FIG. 1) or any other storage location of the system 100. In general, a database is a means of storing information in such a way that information can be retrieved from it. A relational database presents information in tables with rows and columns. A table is referred to as a relation in the sense that it is a collection of objects of the same type (rows). Data in a table can be related according to common keys or concepts, and the ability to retrieve related data from a table is the basis for the term relational database. A database management system (DBMS) handles the way data is stored, maintained, and retrieved. In the case of a relational database, a relational database management system (RDBMS) performs these tasks.

The cognitive charging outlet availability module 160 is configured and arranged to control whether or not the operating system 120 implements the limited functionality mode defined by the energy/application map 150 based on a computer-based cognitive determinations that the mobile computing device 110 is currently in a location where a charging outlet is likely to be available. In some aspects of the invention, the cognitive charging outlet availability module 160 can be configured to utilize cognitive computing algorithms to extract features from training data in order to construct a model of the environment in which the mobile computing device 160 is currently located. In accordance with aspects of the invention, the model of the environment in which the mobile computing device 110 is located includes whether or not a charging outlet is available in the environment. This model is referred to herein as the charge outlet location (COL) model. As an example, the COL model can determine that the mobile computing device 110 is currently located in an automobile that is likely to have a charging outlet coupled to the automobile's battery. As another example, the COL model can determine that the mobile computing device 110 is currently located in a home that is likely to have a conventional electrical outlet. As still another example, the COL model can determine that the mobile computing device 110 is currently located in a public park that is unlikely to have a charging outlet. The COL model can be generated by the cognitive charging outlet availability module 160 classifying the training data and identifying relationships between and among the classified training data.

FIG. 3 depicts a cognitive charging outlet availability classifier 160A, which is an example of how the cognitive charging outlet availability module 160 (shown in FIG. 1) can be implemented. As shown in FIG. 3, the classifier 160A includes machine learning (ML) algorithms 162 configured and arranged as shown. The training data used by the classifier 160A to create the COL model can come from a variety of sources, including, for example, the energy/application map 150, the energy monitor 140, the indoor positioning system 170, the object identification system 172, the GPS 182, and other relevant training data (e.g., Google Maps® data, cell tower triangulation data, Wi-Fi triangulation data, etc.) provided from other training sources over the network 180.

In accordance with aspects of the invention, the classifier (or classifier algorithm) 160A is configured and arranged use the ML algorithms 162 to apply machine learning techniques to the above-described training data. In aspects of the invention, the classifier (or classifier algorithm) 160A uses the ML algorithms 162 to extract features from the training data in order to “classify” the training data and uncover relationships between and among the classified training data. The classifier 160A uses the classified training data and the uncovered relationships between and among the classified training data to create the COL model to generate a classification output 164. In accordance with aspects of the invention, the classification output 164 includes data that identifies whether the mobile computing device 110 is at a charge outlet location. Examples of suitable implementations of the classifier 160A and ML algorithms 162 include but are not limited to neural networks, support vector machines (SVMs), logistic regression, decision trees, hidden Markov Models (HMMs), etc. The learning or training performed by the classifier 160A can be supervised, unsupervised, or a hybrid that includes aspects of supervised and unsupervised learning. Supervised learning is when training data (e.g., Google Maps data) is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like. In accordance with aspects of the invention, the classification outputs 164 (i.e., data indicating whether or not the mobile computing device 110 is at a charge outlet location) is feed back to the classifier 160A and used as additional training data for creating the COL model. In some embodiments of the invention, training data from a variety of instances of the system 100 (shown in FIG. 1) can be accumulated and stored (e.g., at a remote server) and provided through a wired wireless connection (e.g., over the network 180) as additional training data for creating the COL model.

In aspects of the invention, the classifier 160A can be configured to apply confidence levels (CLs) to the classification outputs 164. When the classifier 160A determines that a CL in the classification output 164 is below a predetermined threshold (TH) (i.e., CL<TH), the classification output 164 can be classified as sufficiently low to justify a classification of “no confidence” in the classification output 164, in which case, the mobile computing device 110 would conclude that is it likely not currently located at a charge outlet location. If CL>TH, the classification output 164 can be classified as sufficiently high to justify a determination that it is likely that the mobile computing device 110 is currently located at a charge outlet location. Many different predetermined TH levels can be provided. The classification outputs 164 with CL>TH can be ranked from the highest CL>TH to the lowest CL>TH.

FIG. 4 is a flow diagram illustrating a methodology 400 embodying aspects of the invention. The methodology 400 can be implemented by the mobile computing device 110 shown in FIG. 1, wherein the cognitive charging outlet availability module 160 is implemented as the cognitive charging outlet availability classifier 160A shown in FIG. 3. As shown in FIG. 4, methodology 400 starts at block 401 and moves to decision block 402 where the energy monitor 140 determines whether the mobile computing device 110 is charging. If the answer to the inquiry at decision block 402 is no, the methodology 400 moves to decision block 412 where the energy monitor 140 determines whether the energy level of the energy storage 124 is within the threshold ranges for the energy/application map 150. In the example depicted in FIG. 2, the threshold range is less than 30%. If the answer to the inquiry at the decision block 412 is no, the methodology 400 moves to block 414 where the mobile device 110 remains fully operational, and then moves back to the input to the decision block 402. If the answer to the inquiry at decision block 402 is yes, the methodology 400 moves to block 404 where the mobile computing device 110 suspends the limited functionality mode of the mobile computing device 110. At block 406, the indoor positioning system 170 and/or the GPS 182 determines the current location of the mobile computing device 110, and at block 408, the mobile computing device 110 identifies the current location of the mobile computing device 110 as a charge outlet location. The determination made at block 408 can occur with or without utilizing the COL model generated by the classifier 160A. In other words, in some embodiments of the invention, when mobile computing device 110 is charging, the methodology 400 can conclude that the current location of the mobile computing device 110 is a charging outlet location without having to utilize the COL model.

The methodology 400 moves to decision block 410 where the energy monitor 140 determines whether the mobile computing device 110 is still charging. If the answer to the inquiry at decision block 410 is yes, the methodology 400 returns to block 406 and continues to monitor the current location of the mobile computing device 110. If the answer to the inquiry at decision block 410 is no, the methodology 400 moves to decision block 412 where the energy monitor 140 determines whether the energy level of the energy storage 124 is within the threshold ranges for the energy/application map 150. In the example depicted in FIG. 2, the threshold range is less than 30%. If the answer to the inquiry at the decision block 412 is no, the methodology 400 moves to block 414 where the mobile device 110 remains fully operational, and then moves back to the input to the decision block 402. If the answer to the inquiry at decision block 412 is yes, the methodology 400 moves to decision block 416 where the classifier 160A determines whether the mobile computing device 110 is at a charge outlet location. In some embodiments of the invention, the determination at decision block 416 can optionally be made based on the operations at blocks 406, 408 without having to rely on the classification output 164 generated by the classifier 160A. If the answer to the inquiry at decision block 416 is no, the methodology 400 moves to block 418 and initiates/continues the limited functionality mode, and then moves back to decision block 402. If the answer to the inquiry at decision block 416 is yes, the methodology 400 move to block 420 where the methodology 400 issues an alert to the user of the mobile computing device 110 if no override is currently active. The alert can take a variety of visible, audible, or sensory (e.g., a vibration) forms and notifies the user that the mobile computing device 110 is currently at a charging location. The methodology 400 then moves to decision block 422 and determines whether a user override has been received or is currently active. The override allows the user of the mobile computing device 110 to initiate or continue the limited functionality mode notwithstanding the mobile computing device 110 having determined that the mobile computing device 110 is at a potential charging outlet location. If the answer to the inquiry at decision block 422 is no, the methodology 400 waits at block 424 to allow the user time to respond to the alert issued at block 420, and then moves to the decision block 402. If the answer to the inquiry at decision block 422 is yes, the methodology 400 moves to block 418 and initiates/continues the limited functionality mode, and then moves back to decision block 402.

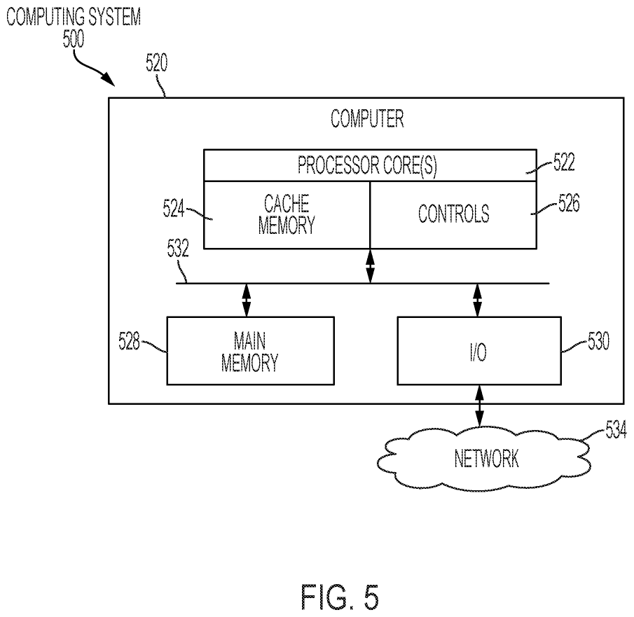

FIG. 5 illustrates an example of a computer system 500 that can be used to implement any of the computer-based components of the various embodiments of the invention described herein. The computer system 500 includes an exemplary computing device (“computer”) 502 configured for performing various aspects of the content-based semantic monitoring operations described herein in accordance aspects of the invention. In addition to computer 502, exemplary computer system 500 includes network 514, which connects computer 502 to additional systems (not depicted) and can include one or more wide area networks (WANs) and/or local area networks (LANs) such as the Internet, intranet(s), and/or wireless communication network(s). Computer 502 and additional system are in communication via network 514, e.g., to communicate data between them.

Exemplary computer 502 includes processor cores 504, main memory (“memory”) 510, and input/output component(s) 512, which are in communication via bus 503. Processor cores 504 includes cache memory (“cache”) 506 and controls 508, which include branch prediction structures and associated search, hit, detect and update logic, which will be described in more detail below. Cache 506 can include multiple cache levels (not depicted) that are on or off-chip from processor 504. Memory 510 can include various data stored therein, e.g., instructions, software, routines, etc., which, e.g., can be transferred to/from cache 506 by controls 508 for execution by processor 504. Input/output component(s) 512 can include one or more components that facilitate local and/or remote input/output operations to/from computer 502, such as a display, keyboard, modem, network adapter, etc. (not depicted).

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented-method of operating a computing device, the computer-implemented method comprising:
receiving, using a processor of the computing device, indoor positioning data and object detection data;
based on an analysis of the indoor positioning data and the object detection data, using the processor to make a determination that a current location of the computing device is a charging outlet location; and
using the processor to disable a limited functionality mode of the computing device based at least in part on the determination that the current location of the computing device is a charging outlet location.

2. The computer-implemented method of claim 1, wherein using the processor to make the determination that the current location of the computing device is a charging outlet location comprises:
determining, using the processor, that the computing device has been charged at a first location;
storing data identifying the first location as a charging outlet location; and
determining that the current location of the computing device is the first location.

3. The computer-implemented method of claim 1, wherein using the processor to make the determination that the current location of the computing device is a charging outlet location comprises:
applying training data to a classifier;
extracting features from the training data to generate a charging outlet location (COL) model configured to model locations that include one or more charging outlets; and
determining that the current location is a charging outlet location based at least in part on comparing the current location to the COL model.

4. The computer-implemented method of claim 1, wherein the limited functionality mode of the computing device comprises:
accessing an energy and application map comprising application types mapped to a cut-off computing device energy level for each of the application types; and
disabling an application of the computing device based at least in part on:
a determination that the application falls within one of the application types; and
a determination that an energy level of the computing device is at or below the cut-off computing device energy level that corresponds to the one of the application types.

5. The computer-implemented method of claim 1, wherein:
the processor of the computing device is further configured to make a determination that another current location of the computing device is not a charging outlet location; and
using the processor to enable the limited functionality mode of the computing device based at least in part on the determination that the another current location of the computing device is not a charging outlet location.

6. The computer-implemented method of claim 5, wherein the processor of the computing device being further configured to make the determination that the another current location of the computing device is not a charging outlet location comprises:
applying training data to a classifier;
extracting features from the training data to generate a charging outlet location (COL) model configured to model locations that include one or more charging outlets; and
determining that the another current location is not a charging outlet location based at least in part on comparing the another current location to the COL model.

7. The computer-implemented method of claim 5, wherein the limited functionality mode of the computing device comprises:
accessing an energy and application map comprising application types mapped to a cut-off computing device energy level for each of the application types; and
disabling an application of the computing device based at least in part on:
a determination that the application falls within one of the application types; and
a determination that an energy level of the computing device is at or below the cut-off computing device energy level that corresponds to the one of the application types.

8. A computer system comprising:
a memory; and
a processor communicatively coupled to the memory;
wherein the processor is configured to:
receive indoor positioning data and object detection data;
based on an analysis of the indoor positioning data and the object detection data, make a determination that a current location of the computing device is a charging outlet location; and
disable a limited functionality mode of the computing device based at least in part on the determination that the current location of the computing device is a charging outlet location.

9. The computer system of claim 8, wherein making the determination that the current location of the computing device is a charging outlet location comprises:
determining that the computing device has been charged at a first location;
storing data identifying the first location as a charging outlet location; and
determining that the current location of the computing device is the first location.

10. The computer system of claim 8, wherein making the determination that the current location of the computing device is a charging outlet location comprises:
applying training data to a classifier;
extracting features from the training data to generate a charging outlet location (COL) model configured to model locations that include one or more charging outlets; and
determining that the current location is a charging outlet location based at least in part on comparing the current location to the COL model.

11. The computer system of claim 8, wherein the limited functionality mode of the computing device comprises:
accessing an energy and application map comprising application types mapped to a cut-off computing device energy level for each of the application types; and
disabling an application of the computing device based at least in part on:
a determination that the application falls within one of the application types; and
a determination that an energy level of the computing device is at or below the cut-off computing device energy level that corresponds to the one of the application types.

12. The computer system of claim 8, wherein the processor of the computing device is further configured to:
make a determination that another current location of the computing device is not a charging outlet location; and
enable the limited functionality mode of the computing device based at least in part on the determination that the another current location of the computing device is not a charging outlet location.

13. The computer system of claim 12, wherein the processor of the computing device being further configured to make the determination that the another current location of the computing device is not a charging outlet location comprises:
applying training data to a classifier;
extracting features from the training data to generate a charging outlet location (COL) model configured to model locations that include one or more charging outlets; and
determining that the another current location is not a charging outlet location based at least in part on comparing the another current location to the COL model.

14. The computer system of claim 12, wherein the limited functionality mode of the computing device comprises:
accessing an energy and application map comprising application types mapped to a cut-off computing device energy level for each of the application types; and
disabling an application of the computing device based at least in part on:
a determination that the application falls within one of the application types; and
a determination that an energy level of the computing device is at or below the cut-off computing device energy level that corresponds to the one of the application types.

15. A computer program product comprising a computer readable storage medium having program instructions embodied therewith, the program instructions executable by a processor of a computing device to cause the processor to perform operations comprising:
receiving indoor positioning data and object detection data;
based on an analysis of the indoor positioning data and the object detection data, making a determination that a current location of the computing device is a charging outlet location; and
disabling a limited functionality mode of the computing device based at least in part on the determination that the current location of the computing device is a charging outlet location.

16. The computer program product of claim 15, wherein making the determination that the current location of the computing device is a charging outlet location comprises:
determining that the computing device has been charged at a first location;
storing data identifying the first location as a charging outlet location; and
determining that the current location of the computing device is the first location.

17. The computer program product of claim 15, wherein making the determination that the current location of the computing device is a charging outlet location comprises:
applying training data to a classifier;
extracting features from the training data to generate a charging outlet location (COL) model configured to model locations that include one or more charging outlets; and
determining that the current location is a charging outlet location based at least in part on comparing the current location to the COL model.

18. The computer program product of claim 15, wherein the limited functionality mode of the computing device comprises:
accessing an energy and application map comprising application types mapped to a cut-off computing device energy level for each of the application types; and
disabling an application of the computing device based at least in part on:
a determination that the application falls within one of the application types; and
a determination that an energy level of the computing device is at or below the cut-off computing device energy level that corresponds to the one of the application types.

19. The computer program product of claim 15, wherein the operations performed by the processor further comprises:
making a determination that another current location of the computing device is not a charging outlet location; and
enabling the limited functionality mode of the computing device based at least in part on the determination that the another current location of the computing device is not a charging outlet location.

20. The computer program product of claim 19, wherein making the determination that the another current location of the computing device is not a charging outlet location comprises:
applying training data to a classifier;
extracting features from the training data to generate a charging outlet location (COL) model configured to model locations that include one or more charging outlets; and
determining that the another current location is not a charging outlet location based at least in part on comparing the another current location to the COL model.
